(19) United States
(12) Patent Application Publication
(10) Pub. No.: US 2019/0362407 A1
(43) Pub. Date: Nov. 28, 2019

(54) BUNDLING ITEMS BASED ON COST AND VALUE

(71) Applicant: International Business Machines Corporation, Armonk, NY (US)

(72) Inventors: Dinesh Garg, Beawar (IN); Alankar Jain, Pittsburgh, PA (US); Aswin Kannan, Chennai (IN); Ramasuri Narayanam, Bangalore (IN); Mukundan Sundararajan, Bangalore (IN)

(21) Appl. No.: 15/988,876

(22) Filed: May 24, 2018

(51) Int. Cl. G06Q 30/06

(52) U.S. Cl. CPC G06Q 30/0631; G06Q 30/0633

(57) ABSTRACT

One embodiment provides a method, including: obtaining information corresponding to a plurality of transactions of an entity, each transaction comprising at least one bundle of items, wherein the information identifies (i) the items included in each bundle and (ii) the cost of each of the bundles to a customer who purchased the bundle; identifying attributes of the items included in the transactions; determining a cost individually attributable to the items included in the transactions; generating at least one bundle of items using the identified attributes of individual items, each of the generated bundles having (i) an identified cost of the bundle to a customer derived from the determined cost of individual items and (ii) an identified perceived value of the bundle to the customer; and providing a recommendation to the entity regarding items to bundle based upon the generated at least one bundle of items.

### BACKGROUND

Consumers purchase items from many different entities, for example, brick-and-mortar stores, online retailers, through catalogs, and the like. When purchasing items a transaction is generated that identifies the items purchased, the date/time of purchase, the cost of the items, either individually or as a group, and the like. The transactions may then be used by the selling entity to identify different aspects. For example, from the transactions, the entity may identify purchase trends, use the information for restocking inventory, use the information to run promotions or advertisements, or the like. If the transactions record additional information, for example, the customer who made the purchase, promotions included in the transaction, or the like, the entity may derive even more information from the transactions. The entity may use the information from the transactions to increase or boost future sales.

### BRIEF SUMMARY

In summary, one aspect of the invention provides a method, comprising: obtaining information corresponding to a plurality of transactions of an entity, each transaction comprising at least one bundle of items, wherein the information identifies (i) the items included in each bundle and (ii) the cost of each of the bundles to a customer who purchased the bundle; identifying, from the obtained information, attributes of the items included in the transactions; determining, from the obtained information, a cost individually attributable to the items included in the transactions; generating at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and providing a recommendation to the entity regarding items to bundle based upon the generated at least one bundle of items.

Another aspect of the invention provides an apparatus, comprising: at least one processor; and a computer readable storage medium having computer readable program code embodied therewith and executable by the at least one processor, the computer readable program code comprising: computer readable program code configured to obtain information corresponding to a plurality of transactions of an entity, each transaction comprising at least one bundle of items, wherein the information identifies (i) the items included in each bundle and (ii) the cost of each of the bundles to a customer who purchased the bundle; computer readable program code configured to identify, from the obtained information, attributes of the items included in the transactions; computer readable program code configured to determine, from the obtained information, a cost individually attributable to the items included in the transactions; computer readable program code configured to generate at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and computer readable program code configured to provide a recommendation to the entity regarding items to bundle based upon the generated at least one bundle of items.

An additional aspect of the invention provides a computer program product, comprising: a computer readable storage medium having computer readable program code embodied therewith, the computer readable program code executable by a processor and comprising: computer readable program code configured to obtain information corresponding to a plurality of transactions of an entity, each transaction comprising at least one bundle of items, wherein the information identifies (i) the items included in each bundle and (ii) the cost of each of the bundles to a customer who purchased the bundle; computer readable program code configured to identify, from the obtained information, attributes of the items included in the transactions; computer readable program code configured to determine, from the obtained information, a cost individually attributable to the items included in the transactions; computer readable program code configured to generate at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and computer readable program code configured to provide a recommendation to the entity regarding items to bundle based upon the generated at least one bundle of items.

A further aspect of the invention provides a method, comprising: obtaining historical transaction data corresponding to transactions between an entity and customers of the entity, wherein the historical transaction data identify bundles of products each having (i) a cost to the customer to purchase the bundle and (ii) a value of the bundle as perceived by the customer; determining the cost of individual products included within the bundled products; determining value attributable to each individual product included within the bundled products; and creating new bundles of products from the individual products by identifying products (i) having perceived value to a potential customer that would attract the potential customer to purchase the bundle of products and (ii) having a cost resulting in an acceptable profit margin on the products to the entity.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of filtering sounds based upon a generated desirability index for a user.

FIG. 2 illustrates an example desirability index.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

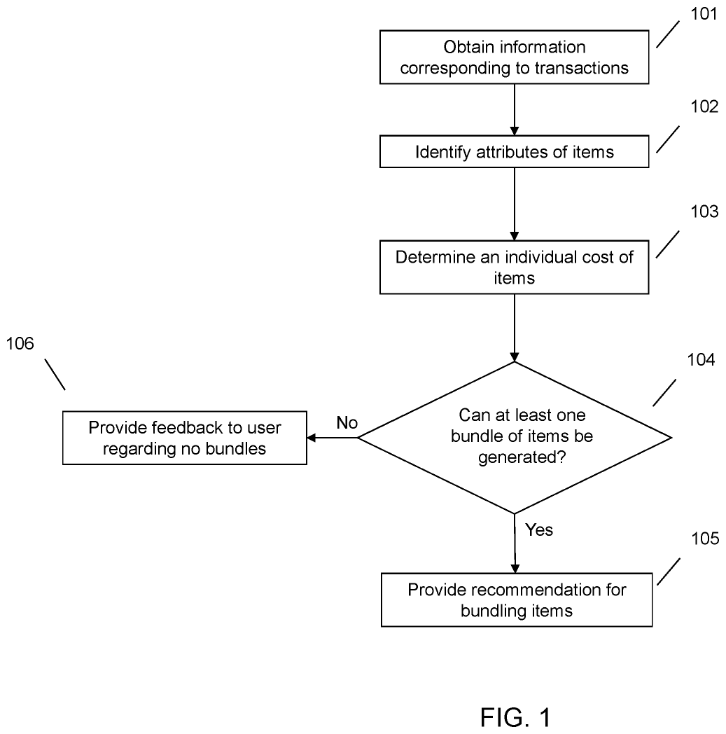

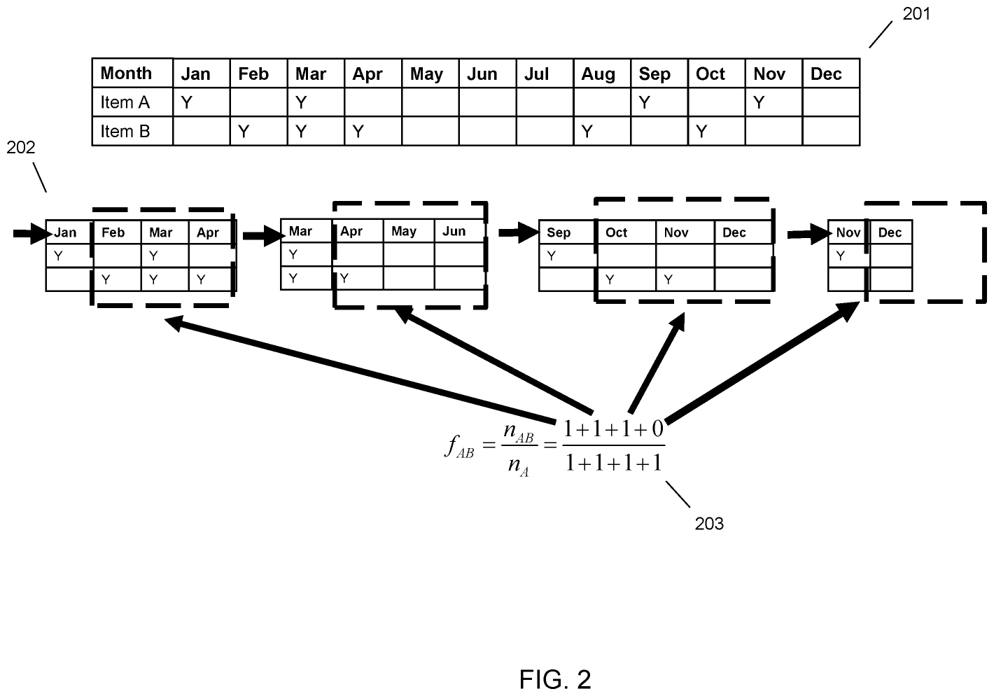

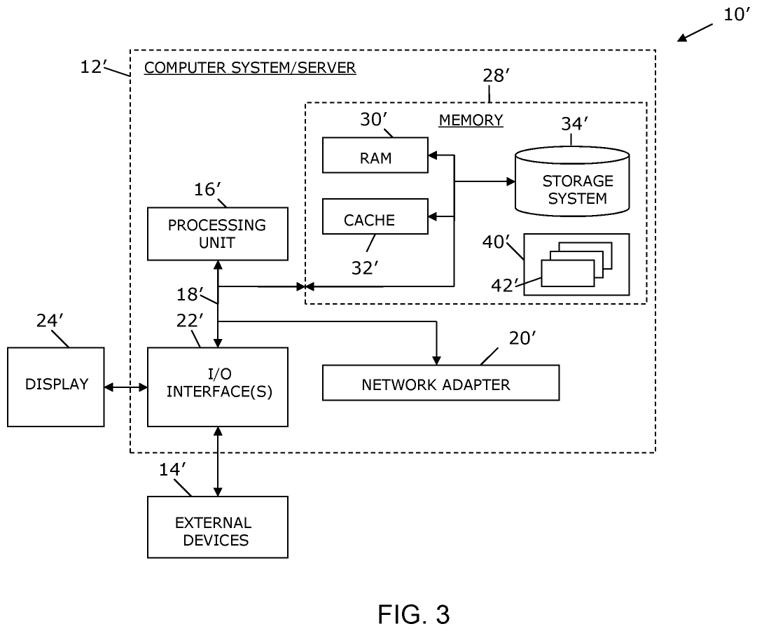

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

One way for entities to boost sales is to bundle items or sell a variety of items for a single price. Bundling items may encourage a customer to buy items that may have a relationship to each other, but may not have been bought together without the bundle. For example, while customers may buy butter and bread and use these items together, the customer may not buy the butter and bread in the same transaction. However, if the entity selling the butter and bread offer a bundle, the customer may be enticed to buy both items within the same transaction. As another example, when a customer buys an electronic device, they may not want to purchase a warranty plan for the electronic device. However, if the entity bundles the warranty plan with the electronic device, the customer may be enticed to buy the warranty plan with the electronic device. Therefore, bundling may be useful to an entity when the entity is attempting to boost sales of a particular item, increase revenue generated from a single item, or the like.

Typically when bundling items, the price for the bundle of items that is charged to the customer is not merely the price of the individual items added together. For example, if an entity bundles a bunch of bananas having an individual cost of $2.69 with a gallon of milk having an individual cost of $3.49, the bundle price may be $5.50, which is less than the cost of the sum of the individual items. This bundle discount may encourage the customer to buy both items within the same transaction as opposed to purchasing the items individually in different transactions. Additionally, since the customer is receiving a discount, the customer may be enticed to purchase an item they had not previously planned on purchasing. For example, a customer may not have been planning on purchasing a protection plan with an item. However, if the customer receives a discount on the protection plan when purchasing the plan in conjunction with the corresponding item, the customer may be tempted to purchase the protection plan. This increases the revenue to the entity.

Conventional bundling techniques rely on users or entities to identify items that should be bundled together and also to set a price for that bundle of items. Identifying items for bundles may be somewhat intuitive because the items may be obviously related. However, customers may tend to purchase certain items together even though the interrelationship of those items may not be obvious. However, the entity could bundle these items to entice more customers to purchase those items and generate more revenue. Additionally, determining the cost for a bundle of items may be difficult. While some customers may be willing to purchase a bundle of items at one price, another set of customers may not be willing to pay the same price for the bundle of items, but may be willing to purchase the bundle at a lower price. In other words, the perceived value of the bundle of items to customers can vary. The variance in perceived value may be based upon different time frames, the supply of items in the bundle within the marketplace, the bargaining power of the purchaser, the customer purchasing the bundle, and the like. Due, at least in part, to this variance, determining a price or cost for the bundle of items that entices a large number of customers to purchase the bundle while maintaining a maximum profit for the entity may be very difficult.

Thus, the conventional techniques of manually selecting products or items to be bundled and determining a cost for the bundle of items may result in inconsistent purchasing results. For example, during one time frame or for a particular customer a bundle of items at a particular cost may result in a large number of purchases of the bundle. However, the same bundle of items for the same price at a different time frame or for a different group of customers may result in few or no purchases. Another problem with the manual selection of products to bundle and selecting a price is that the entity may lose money on the transactions. For example, while customers may purchase the bundle at the cost, the customers may have been willing to pay more for the same bundle of items. Therefore, the entity has lost revenue on these purchases.

Online marketplaces may provide a unique opportunity where items can be promoted for bundling dynamically as a potential purchaser looks at different items webpages on the marketplace website or adds items to the shopping cart. Typically, the online marketplace uses either a similarity measure to identify items to promote or identifies items that were purchased by other customers who purchased the item the potential customer is viewing. The online marketplace may then include these items as advertisements or “recommendations for you” in conjunction with the displayed webpage.

However, while the online marketplace promotes these items, the online marketplace does not typically offer a bundle discount for purchasing the items together. A reason for this is that it is difficult to dynamically determine a price for the bundle of items as the potential customer is viewing the webpage. The marketplace would need to be able to set a dynamic price based upon the item that the potential customer is currently viewing. Since the marketplace does not have an idea of which items a single customer may view, it is difficult, if not impossible, to preset a bundle price. Thus, the customer may not be enticed to purchase the additional item(s) since the customer is not receiving a discount for purchasing this additional item. However, the customer may have purchased the additional item if a bundle discount would have been available. Therefore, the online marketplace may be losing revenue due to this inability to dynamically set bundle prices.

Accordingly, the techniques and systems as described herein provide a system and technique for generating bundles of items and costs for that bundle of items from transaction history related to an entity. In other words, the techniques and systems described herein can obtain information from historical transactions to be used in determining a bundle of arbitrary items and the cost for that bundle of arbitrary items. The system may obtain information corresponding to a plurality of transactions of an entity, for example, historical transactions of an online marketplace, completed transactions of a brick-and-mortar store, and the like. Each transaction may include information related to a bundle of items and may identify the items that were included in each bundle and the cost of the bundle to the purchasing customer. The transaction information may include additional information, for example, a profile associated with the purchasing customer, a time/date timestamp of the transaction, and the like.

From the obtained information the system may identify attributes of the items and a cost individually attributable to each item included within a bundle or the transaction. The system may also determine a perceived value of each item included in the bundle. The perceived value may be the value that the customer attributes to the item. The system can generate one or more bundles of items using the identified attributes of the individual items. These generated bundles may be dynamically generated in response to a user input, for example, a user viewing a particular product or product webpage, a user search query, a potential customer profile, or the like. With the generated bundles the system may identify the price that should be set for the bundle of items, which may be based upon the determined cost of each individual item included in the bundle. The system may also identify a perceived value of the bundle of items. When generating the bundles the system may also receive information related to a parameter with respect to generating the bundles. For example, a user may identify a maximum or minimum price of the bundle. After generating the bundles, the system may provide a recommendation to the entity regarding which items to bundle and the cost that should be set for the bundle.

Such a system provides a technical improvement over current systems for providing bundle item discounts. The described systems and methods provide a technique that allows an entity to dynamically identify items to be bundled and a price for that bundle of items. The described system and method uses historical transaction information to determine bundled items, a cost for the bundled items, and a perceived value of the bundle of items. Using this information the system can identify an individual cost and value attributable to each individual item. Thus, when a potential customer is viewing a particular item, the system can dynamically create a suggested bundle and a suggested price for that bundle of items that may entice the customer to purchase the additional item(s). Thus, the system provides a method for dynamically identifying items to be bundled and a price for those bundled items that is not possible using conventional manual techniques. Additionally, since the bundles and prices can be dynamically determined, an entity does not have to manually set bundles and prices for all customers. Rather, the entity can bundle items and set costs that are unique to a particular consumer and based on that consumer's purchase history. Accordingly, the described system and method provide a technique for generating recommendation for bundles that is directed to a particular consumer or product, and, therefore, provides a technique for increasing revenue generated by an entity by targeting the items bundled and the cost of the bundled items. Such a technique is not possible using conventional systems or techniques.

FIG. 1 illustrates a method for generating bundles of items and costs for that bundle of items from transaction history related to an entity. At 101 the system may obtain information corresponding to a plurality of transactions of an entity. The transactions may be associated with a single entity or may include transactions that were completed or performed at a different entity, where the first entity has access to the transaction history of the different entity. For example, entities may sell, trade, or otherwise provide transaction details of one entity to other entities. Thus, the information may include any transactions that the entity has the ability to access. The transactions may include purchases that were completed by a customer, quotations provided by the entity to a potential customer, and the like.

Each of the transactions may include a bundle of items or products, where a bundle of items includes more than one item that was purchased within a single transaction. While possible, a bundle of items does not necessarily mean that the purchase of one item within the transaction was dependent upon another item in the same transaction. Additionally, while possible, a bundle of items does not necessarily mean that the customer received a discount for purchasing the group of items. Rather, a bundle of items may simply mean that the customer purchased more than a single item within the transaction. More than a single item may also include the purchase of a single item in a quantity greater than one. For example, more than one package of lightbulbs in a single transaction without the purchase of other items may comprise a bundle of items.

The system does not have to obtain a representation of the transactions themselves, for example, a receipt corresponding to the transaction, a shopping cart reproduction, or the like. Rather, the system may merely obtain information that corresponds to or is related to the transaction. This information may include an identification of the items included in the transaction, for example, a description of the items, item identifiers, a name of the items, or the like. The information may also include a quantity of the items purchased in the transaction and a cost of the transaction to the purchaser. The information may also include additional information, for example, any discounts that were included in the transaction, a name of the customer who performed the transaction, a timestamp (e.g., date, time, etc.) of when the transaction was performed, or any other ledger based detail. In the case that information related to the purchasing customer is available, the system may either access or generate a profile associated with that customer. The profile may indicate the frequency of purchases of the customer, historical transactions of the customer, a bargaining power of the customer (e.g., if the customer purchases large quantities the customer may having a higher bargaining power than a customer who purchases small quantities, if the customer is a frequency customer the customer may have a higher bargaining power than a customer who is an occasional customer, etc.), a company that the customer is associated with, an importance of the customer to the entity which may influence the customer's bargaining power, and the like.

From the obtained information, at 102, the system may identify attributes of the items included in the transactions. The attributes may include physical attributes of the items included in the transaction. Physical attributes may include the physical design specifications of the products, for example, a color of the product, a size of the product, operating parameters of the product, and the like. Some items purchased within a single transaction may have an effect or influence on the purchase of another item within the transaction. This effect or influence may be based, at least partially, on the physical attributes of the products. Thus, by identifying the attributes, the system can determine whether the co-occurrence of products within a single transaction is due to the influence of one product on the other or merely a coincidence. The system may group or classify the attributes into different groups or classifications. By grouping or classifying the attributes, the system may more easily determine if one product influenced the purchase of another item within the same transaction, or across transactions.

As an example, the system may classify each of the attributes into one of the following groups: portability, usability and dimensions, storage, components, and maintenance. Portability may refer to the extent that the product can be compactly packaged. Using the example of computers, a mainframe may be considered not portable while a laptop would be considered portable. Thus, the portability of the laptop may influence the purchase of external devices, for example, external storage devices, external displays, external media readers, external peripherals, and the like. However, since mainframe computers are not portable, they do not lend themselves to influencing the purchase of such external components. Portability may not refer to just physical portability, but may also refer to a virtual portability. For example, in the case of software, a software application that can connect to a cloud environment may be considered portability, whereas a software application that cannot connect to the cloud may be considered non-portable. Thus, portability may refer to the ability of the user to use the product anywhere.

Usability may refer to the physical appearance and design of the product, for example, the dimensions, weight, appearance of a graphical user interface, color, and the like. For example, a heavy hardware device may influence the purchase of a particular type of packaging. Storage refers to the size of information that can be stored and is predominantly an attribute in hardware related products. For example, a hard disk drive may influence the purchase of a protective case or scratch protectors, whereas a universal serial bus drive would not have the same requirements. Components may refer to the internal components that are used to create the products, for example, an engine, transistor, script, interface, and the like. Maintenance may refer to the servicing that is required or recommended for a product. Different items may be of a nature that servicing is required for the continued performance of the item. For example, the purchase of a car may influence the purchase of a maintenance package for oil changes and fluid level checks, whereas the purchase of paper may have no required maintenance.

At 103 the system may determine a cost of each item within the transactions. In other words, the system may determine a cost that is individually attributable to a single item within the transaction. The determination of the individual cost may be as simple as identifying a line item cost or dividing a line item cost by a quantity of the item purchased. Determination of the individual cost may also take into account any discounts that are associated with the transaction, for example, if the purchaser used a coupon to receive 20% off the entire purchase, the system may determine the individual item cost by either ignoring the coupon or by including the coupon in the line item cost.

However, the determination of the individual cost of an item becomes more complicated for bundled items, or items that have a combined cost different than the cost of the individual items within the bundle. Using the milk and banana example, where the bunch of bananas has an individual cost of $2.69, the gallon of milk has an individual cost of $3.49, but the bundle price is $5.50, it may be difficult to determine which portion of the $5.50 should be attributed to the milk and which portion should be attributed to the bananas. Therefore, the system may use one or more techniques. For example, the system may simply proportionally attribute the bundled cost to each of the individual items. Alternatively, the system may correlate different transaction to determine the attributable cost. For example, if one transaction includes the banana and milk bundle for $5.50 and another transaction includes a milk and egg bundle for $6.00, the system may formulate a mathematical equation to determine how much the milk cost in each transaction. In other words, using all the transaction history, the system can determine which the individual cost of items, even when the items are bundled. Other techniques for determining the cost of individual items are contemplated and possible.

The system may also determine a perceived value of the items within a bundle. A perceived value may be a value that a customer assigns or identifies for each item or for a bundle of items. In other words, the perceived value is a feel for how much a customer thinks that an item is worth, irrespective of the actual cost of the item. Examples of value may include nostalgic and perceptional value (e.g., an item may be more valuable to a customer for sentimental reasons, an older person may value older items higher because they had those same things as a child, etc.), aesthetic value (e.g., some customers may value a particular look or feel of a product higher than a look or feel of another product even if the performance is the same, different aesthetic features may be valued higher, etc.), cursory value (e.g., something that saves a user time may be valued higher, the purpose of a product may be valued higher, etc.), usability value (e.g., a product that is easier to use may be valued higher, a product that a user is familiar with may be valued higher, etc.), and the like. Since a perceived value is something that a human determines and that may be different for each human or customer, the system may use or incorporate a cognitive analysis to determine or assign a value to each item. Thus, the system may employ a sub-modular function to determine the value of individual items or bundled items. Determination of value will be described in more detail below.

At 104 the system may determine if a new bundle of items can be generated. In generating the bundles, the system may attempt to generate a bundle that would result in a high likelihood of purchase by a customer and also maximizes the profit to the entity providing the item. Thus, the system attempts to identify a bundle that a customer would perceive as having a high value as compared with the actual cost of the item, thereby enticing the customer to purchase the item. Therefore, the generation of the bundles can be dynamic and responsive to one or more user inputs, either a customer input or an entity input. An example user input may include an entity providing a potential customer profile, for example, the entity may be attempting to entice the customer to purchase one or more items at the entity and may provide either the name of the customer where the system can access the customer profile or by directly providing the customer profile to the system. The system may then use this customer profile to attempt to generate bundles of items that may be useful or enticing to this customer.

Another example user input may be a potential customer looking at a particular product, for example, by accessing an online marketplace product webpage. As another example, the user input may include a customer either physically or virtually placing a product in a shopping cart associated with the customer. Responsive to this input, the system may attempt to generate one or more potential bundles. In other words, the generation of the bundles may be dynamic and may occur in near real-time responsive to input that is currently being received by the system. Thus, the generation of the bundles may also be unique to the particular customer. In other words, a bundle generated for one customer may be different than a bundle generated for another customer.

The bundles of items do not have to include bundles that were included in the transactions. In other words, the bundle of items may include arbitrary items that were not necessarily bundled in a previous transaction. In generating the bundles, the system attempts to generate a bundle that will entice either the particular customer or a group of customers to purchase the bundle. Thus, the system attempts to not only select items that would appeal to the particular customer or a variety of customers, but also attempts to identify a price that the generated bundles should be priced at to entice the customer(s) to purchase the bundle. The price attributable to the bundle of items may be derived at least in part on the cost of individual items as determined at 103. However, the cost of a bundle of items does not have to be the sum of the individual parts of the bundle. Rather, the cost of the bundle is likely to be different than the sum of its individual parts.

In determining the cost that should be attributed to the bundle of items, the system may employ one or more mathematical functions to combine the costs of the individual items within the generated bundle. For example, the system may use a non-linear mathematical function, a linear mathematical function, a non-smooth mathematical function, and the like. Example equations may include a quadratic equation, a linear equation, or the like. In these mathematical functions, the system may include prices where one product influences the price of another function. In other words, the function used to determine the cost may include cross terms where one product influences the cost or price of another product. While the system attempts to determine a cost that maximizes the profit to the entity, it should be understood that profit may not be merely monetary. Rather, an entity may consider profitability in the context of productivity, quality, or the like.

To determine the perceived value of a bundle, the system may use one or more sub-modular functions and perform regression. For example, using the following function:

min ∥ƒᵢ(Sᵢ)−vᵢ∥²

s.t: ƒ∈F

A sub-modular function is a set function whose value is based upon the function that when adding more items to the set, the difference in the incremental value of the entire set decreases. In other words, as more items are added to the set, the total value of the increment of value added decreases. As an example, with two items in a set, the total value of the set may be equal to 95% of the individual value of both items added together. However, when a third item is added, the value of the set increases from the value of the two items, but the total value may only be equal to 80% of the individual values of the three items added together. The sub-modular function may be a linear sub-modular function, for example, ƒ=α^{T}p, where alpha is a set of coefficients to be estimated (variables) and p is the set of determined prices. The sub-modular function may be a monotone sub-modular function, for example, as illustrated by: ƒ(Sᵢ)=>ₖ∝ₖ Sᵢ(k) or ƒ(Sᵢ)=Σₖ max(αₖ, 0)Sᵢ(k). However, the sub-modular function may be other types of functions and is dependent on the items and the purpose of the entity, for example, whether the entity is attempting to maximize profit, sell a large quantity of a particular item, or the like. Example functions may include exponential, cube roots, absolute value, or the like functions. Additionally, the system may use a combination of functions in a single calculation, for example, F={e^{|S|}, |S|^{k}, . . . ,

$$\sqrt[3]{n ( S )} \} .$$

The system may also use inter-item frequencies to model or quantify the sets used in the submodular space. In other words, the coefficients or weights denoted by alpha, as described above, may be computed based on estimated inter-item frequencies, for example, using the equation:

$${α}_{i} = {kf}_{i} = {\sum }_{j ∈ J} {f}_{ij} = {\sum }_{j} \frac{{n}_{ij}}{n} .$$

Additionally, like the determined price, the perceived value of one item may be based upon the inclusion of another item within the bundle. For example, if the system determines that the purchase of one item was closely followed by the purchase of the second item, the system may determine that one item is dependent on the other item. Thus, one technique for determining a co-dependency for an item is to use a sliding time window, for example, as shown in FIG. 2. The system may generate a calendar, chart, graph, or other mechanism for illustrating the co-occurrence of two items, for example, as shown at 201. In the calendar 201 of FIG. 2 the purchase of an item within a particular month is shown as a “Y”. Thus, the calendar 201 illustrates that Item A was purchased in January, March, September, and November, whereas Item B was purchased in February, March, April, August, and October. The system then uses a sliding time window mechanism, for example, as illustrated at 202, to identify whether the purchase of one item may have influenced the purchase of the second item. While the timeframe for the sliding window 202 shown in FIG. 2 is three months, the timeframe for the sliding time window may be configurable. The system may then use a function 203 to identify a dependency of the purchase of one item on the purchase of another item. This identification may include comparing the value of the evaluated function to a predetermined threshold and, if the value meets or exceeds the threshold, the system may identify a dependency of one item on another.

When generating the bundles, the system may be constrained by one or more parameters related to an attribute of the resulting generated bundle(s). These parameters may be tunable, or selectable, by a user or entity. Examples of tunable parameters include a constraint on a minimum and/or maximum price of either individual items included in the bundle or the entire bundle itself, a number of items included in the bundle, physical attributes of items included in the bundle (e.g., portability, usability and dimensions, storage, components, maintenance, etc.), the mathematical function to be used for determining the cost of the bundle (e.g., non-linear, linear, non-smooth, etc.), a function for determining the perceived value of the bundle (e.g., linear sub-modular function, nonlinear submodular function, a combination thereof, etc.), or the like.

If the system cannot generate one or bundles of items at 104, for example, the tunable parameters result in no generated bundles, the system may provide feedback to the user or entity regarding the fact that no bundles could be generated at 106. If, however, one or more bundles could be generated at 104, the system may provide a recommendation to the entity regarding items that should be bundled and a price that the bundled items should be sold at. As stated above, the recommendation may be partially based upon a profile of a potential customer. Thus, the recommendation may be unique to a particular user or unique to a particular user input. Providing the recommendation to the entity may include providing a notification or report of proposed or recommended bundles and prices. Alternatively, providing the recommendation may include displaying the generated bundles on a webpage, for example, a webpage that is currently being visited by the potential customer. Display of the generated bundle on the webpage may be contingent on parameters set by the entity. For example, the entity may indicate that bundles having a percentage discount below a value may be automatically displayed, while bundles having a percentage discount above a value must be approved by the entity before being displayed. As another example, the entity may indicate that the inclusion of certain items within a bundle require approval, while other items do not require approval.

Thus, the systems and methods as described herein provide a technique for dynamically generating bundles and prices to be attributed to the bundles using historical transaction information. Thus, rather than static bundles and prices as in conventional techniques, the systems and methods as described herein can provide bundles that would entice customers to purchase the bundle based upon information identified about purchase trends, particular customer traits, or the like. Therefore, the described systems and methods provide a system that is more fluid and dynamic that conventional systems and which increase the number of purchases of bundles while still maintaining or maximizing a particular profit for the entity.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”).

Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
obtaining information corresponding to a plurality of transactions of an entity, each transaction comprising at least one bundle of items, wherein the information identifies (i) the items included in each bundle and (ii) the cost of each of the bundles to a customer who purchased the bundle;
identifying, from the obtained information, attributes of the items included in the transactions;
determining, from the obtained information, a cost individually attributable to the items included in the transactions;
generating at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and
providing a recommendation to the entity regarding items to bundle based upon the generated at least one bundle of items.

2. The method of claim 1, wherein the obtained information identifies a profile of the customer who purchased the bundle, the profile indicating importance of the customer to the entity.

3. The method of claim 1, comprising receiving user input identifying a profile of a potential customer and wherein the provided recommendation is based upon the profile of the potential customer.

4. The method of claim 1, wherein identifying the cost of the generated bundle comprises employing a mathematical function to combine the costs of the individual items within the generated bundle, wherein the mathematical function is selected from the group consisting of: a linear mathematical function, a non-linear mathematical function, and a non-smooth mathematical function.

5. The method of claim 1, wherein the at least one parameter comprises at least one parameter selected from the group consisting of: a maximum price of each item included within a generated bundle, a minimum price of each item included within a generated bundle, a number of items included within a generated bundle, attributes related to items included within a generated bundle, and a function to be used for generating the bundles.

6. The method of claim 1, wherein the perceived value of the generated bundle is identified using a sub-modular function.

7. The method of claim 1, wherein the transactions include date of purchase timestamps and comprising identifying, from the obtained information, a dependency of one item on another item using a sliding time window on the transaction purchase timestamps to identify a correlation between the purchasing of one item and the purchasing of a second item.

8. The method of claim 7, wherein the perceived value of one item within a generated bundle is dependent on the perceived value of another item within the generated bundle, wherein the dependency is identified from the sliding time window.

9. The method of claim 1, wherein the cost of one item within the generated bundle is influenced by the cost of another item within the generated bundle.

10. The method of claim 1, wherein the generated bundles comprise bundles comprising items that were not bundled in the obtained information.

11. An apparatus, comprising:
at least one processor; and
a computer readable storage medium having computer readable program code embodied therewith and executable by the at least one processor, the computer readable program code comprising:
computer readable program code configured to obtain information corresponding to a plurality of transactions of an entity, each transaction comprising at least one bundle of items, wherein the information identifies (i) the items included in each bundle and (ii) the cost of each of the bundles to a customer who purchased the bundle;
computer readable program code configured to identify, from the obtained information, attributes of the items included in the transactions;
computer readable program code configured to determine, from the obtained information, a cost individually attributable to the items included in the transactions;
computer readable program code configured to generate at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and
computer readable program code configured to provide a recommendation to the entity regarding items to bundle based upon the generated at least one bundle of items.

12. A computer program product, comprising:
a computer readable storage medium having computer readable program code embodied therewith, the computer readable program code executable by a processor and comprising:
computer readable program code configured to obtain information corresponding to a plurality of transactions of an entity, each transaction comprising at least one bundle of items, wherein the information identifies (i) the items included in each bundle and (ii) the cost of each of the bundles to a customer who purchased the bundle;
computer readable program code configured to identify, from the obtained information, attributes of the items included in the transactions;
computer readable program code configured to determine, from the obtained information, a cost individually attributable to the items included in the transactions;
computer readable program code configured to generate at least one bundle of items using the identified attributes of individual items, each of the generated bundles having (i) an identified cost of the bundle to a customer derived from the determined cost of individual items and (ii) an identified perceived value of the bundle to the customer, wherein the generating is performed in view of at least one parameter that constrains an attribute of the resulting generated at least one bundle of items; and
computer readable program code configured to provide a recommendation to the entity regarding items to bundle based upon the generated at least one bundle of items.

13. The computer program product of claim 12, wherein the obtained information identifies a profile of the customer who purchased the bundle, the profile indicating importance of the customer to the entity.

14. The computer program product of claim 12, comprising receiving user input identifying a profile of a potential customer and wherein the provided recommendation is based upon the profile of the potential customer.

15. The computer program product of claim 12, wherein identifying the cost of the generated bundle comprises employing a mathematical function to combine the costs of the individual items within the generated bundle, wherein the mathematical function is selected from the group consisting of: a linear mathematical function, a non-linear mathematical function, and a non-smooth mathematical function.

16. The computer program product of claim 12, wherein the at least one parameter comprises at least one parameter selected from the group consisting of: a maximum price of each item included within a generated bundle, a minimum price of each item included within a generated bundle, a number of items included within a generated bundle, attributes related to items included within a generated bundle, and a function to be used for generating the bundles.

17. The computer program product of claim 12, wherein the perceived value of the generated bundle is identified using a sub-modular function.

18. The computer program product of claim 12, wherein the perceived value of one item within a generated bundle is dependent on the perceived value of another item within the generated bundle.

19. The computer program product of claim 12, wherein the cost of one item within the generated bundle is influenced by the cost of another item within the generated bundle.

20. A method, comprising:
obtaining historical transaction data corresponding to transactions between an entity and customers of the entity, wherein the historical transaction data identify bundles of products each having (i) a cost to the customer to purchase the bundle and (ii) a value of the bundle as perceived by the customer;
determining the cost of individual products included within the bundled products;
determining value attributable to each individual product included within the bundled products; and
creating new bundles of products from the individual products by identifying products (i) having perceived value to a potential customer that would attract the potential customer to purchase the bundle of products and (ii) having a cost resulting in an acceptable profit margin on the products to the entity.
